(19) United States
(12) Patent Application Publication
(10) Pub. No.: US 2015/0365752 A1
(43) Pub. Date: Dec. 17, 2015

(54) Support Structures For Music Components, Comprising Integrated DI

(71) Applicant: Lanny J. Mcintosh, Austin, IN (US)

(72) Inventor: Lanny J. Mcintosh, Austin, IN (US)

(21) Appl. No.: 14/740,148

(22) Filed: Jun. 15, 2015

Related U.S. Application Data
(60) Provisional application No. 61/998,036, filed on Jun. 16, 2014.

(51) Int. Cl. H04R 1/08; H04R 3/00; H04R 1/02

(52) U.S. Cl. CPC H04R 1/08; H04R 1/02; H04R 3/00

(57) ABSTRACT

Provided in various example embodiments is a support structure for a microphone, a musical instrument, or other music component, the support structure comprising therein the components of a direct box or “DI” box, such as electrical components configured to convert a high-impedance, line level, unbalanced output signal from a musical instrument to a low-impedance microphone-level balanced input signal. The invention eliminates the need for a separate direct box, thereby eliminating unsightly clutter and dangerous trip hazards from the stage floor.

### CROSS-REFERENCE TO RELATED APPLICATIONS

This application claims priority to, incorporates by reference, and is a non-provisional of U.S. patent application Ser. No. 61/998,036, filed Jun. 16, 2014.

### FEDERALLY SPONSORED RESEARCH OR DEVELOPMENT

None.

### TECHNICAL FIELD

The subject matter disclosed herein relates generally to audio signal processing components for musical instruments, and more specifically to support structures for music components, comprising therein the components of a direct box, also known as a DI unit, DI box, or simply DI (variously claimed to stand for direct input, direct injection, direct induction or direct interface).

### BACKGROUND

The present invention relates generally to audio signal processing components, and more specifically to a “direct box” for coupling instrument audio signals having unbalanced high-impedance formats to audio console inputs designed to receive balanced low-impedance audio signal formats.

Popular musical instruments in common use today, such as electric guitars and acoustic instruments, typically employ a magnetic pickup, a transducer, or a microphone through which sound produced by the instrument is converted into an electrical audio signal for amplification, processing, and recording.

In some musical arrangements, such as on-stage performances, the instrument being played is typically situated at a substantial distance away from the electronic equipment used for amplifying, processing, and recording the audio signals, necessitating a lengthy transmission line. With the exception of a few high-cost professional instruments, most musical devices employ pickups and microphones which are characterized as high-impedance, unbalanced devices, having impedance in the range of three thousand to fifty thousand ohms. Compared to the low-impedance balanced microphones found in professional instruments, which may have impedance on the order of three hundred ohms or less, these high-impedance devices and the lengthy transmission lines connecting them are susceptible to external hum fields and signal noise which can substantially degrade the audio signal quality.

For example, typical environments contain multiple alternating-current power sources that can produce hum fields. These fields can be introduced into the audio signals through single-ended high impedance sources in the audio setup. The degree of hum not only adds to the overall signal noise present in the audio system, but reduces the dynamic range of the audio signals in the system by reducing the signal level difference between the lowest note and the quietest note.

Impedance-matching transformers have long been used to reduce external hum fields and signal noise over transmission lines by converting electrical audio signals from the high-impedance, unbalanced formats employed by common musical instruments into low-impedance, balanced formats for better audio signal quality, such as shown in U.S. Pat. No. 5,612,646 to Berning, the entirety of which is incorporated herein by reference. However, the use of impedance-matching transformers can have certain limitations in specific situations. The transformers necessitate components of a large physical size and relatively high cost, and suffer from a reduction in dynamic signal ranges, an increase in signal distortion level, and the possibility of noise saturation due to transformer overload. Additionally, a typical transformer-coupled direct box cannot respond to the leading edge transients contained in musical audio signals, creating an audible output signal distortion. For example, a musical instrument like the English horn is capable of reaching sixty-percent of its normal peak amplitude in five milliseconds. Other instruments can often have rise times that vary from fifty milliseconds to two-hundred milliseconds, and a hand-clap can rise as fast as half a millisecond. Typical transformers are not capable of producing an adequate signal response within these short time periods

One alternative to an impedance matching transformer includes the use of active electronic circuits in a direct box by employing solid-state transistor circuitry or vacuum-tube circuitry to couple the high-impedance instruments directly to the low-impedance audio components. Active electronic devices incorporating vacuum tubes, such as shown in U.S. Pat. No. 5,343,159 A to Butler issued August 30, 1994, the entirety of which is incorporated herein by reference, suffer several disadvantages, including higher manufacturing costs, reliability problems, and an increase in audio signal distortion levels. Similarly, active electronic devices employing solid-state transistor circuitry are typically complex and costly designs, requiring an external alternating-current power source such as a wall outlet, or a battery-type power supply.

An active direct box typically has a small buffer amplifier in it and converts the signal to a differential signal using either a transformer, or another inverting amplifier to create the negative half of the differential signal. One advantage of an active direct box over a passive box is that it can have much higher input impedance, thus putting less load onto the instrument to which it is connected. This can be important for example with inductive guitar pickups, as loading can affect the high-frequency response of these devices. Also, an active direct box can have gain, which is useful for weak signals. The active circuitry is quite often powered by power fed down a microphone lead from the mixing desk. This is known as a phantom power system, an example of which is disclosed in U.S. Pat. No. 4,737,735 A to Kampes issued Apr. 12, 1988, the entirety of which is incorporated herein by reference. The signal level that a direct box receives can vary widely from application to application and while the microphone input of a mixing desk may have an input gain control, the input cannot cope with very high signal levels. For this reason most direct boxes will have a selectable attenuator (known as a pad), on the input so that a high signal level can be attenuated. Examples of known active direct boxes are given in U.S. Pat. No. 6,020,788 A to Comeau issued Feb. 1, 2000, and U.S. Pub. No. 2004/0151330 A1 to Lehmkuhl published Aug. 5, 2004, both of which are incorporated herein by reference in their entireties.

Regardless whether they are active or passive, as depicted in FIG. 1 these direct boxes 70 are typically placed on the stage floor 80 near the feet of the performer 20, so that the performer's instrument(s) 30 can be readily plugged-in to the direct box(es) 70 with a minimal length of interference-prone cable 90, which is/are then plugged-in to wires 92, 94 leading to a distant mixing board and other components, for instance. But in the already-crowded stage area 80 where the performer 20 must perform, the presence of one or more electronics boxes 70 laying on the stage floor 80 is a visually unappealing trip-hazard, and an unwanted distraction and danger for the performer 20. What is needed is a convenient and visually appealing way to remove the direct box 70 from the stage floor and place it out of sight while keeping it near the performer's instrument(s) 30.

### SUMMARY

The present invention elegantly addresses the above challenges and provides numerous additional benefits as will be apparent to persons of skill in the art. Provided in various example embodiments are support structures for music components such as microphones and musical instruments, wherein the support structures themselves have all the components of one or more direct boxes—passive or active or both—incorporated directly into the support structures. For example and not by way of limitation, all the operative components of one or more direct boxes can be incorporated into a microphone stand, a keyboard stand, or support structures for any other suitable instruments or musical components.

Accordingly, provided in various example embodiments is a support structure for a microphone, the support structure comprising therein electrical components configured to convert a high-impedance, line level, unbalanced output signal from a musical instrument to a low-impedance microphone-level balanced input signal. In various example embodiments the support structure comprises a base portion of a microphone stand. In various example embodiments the electrical components are configured to function passively without a power source aside from the unbalanced output signal. In various example embodiments the electrical components comprise an audio transformer configured to act as a balun. In various example embodiments the electrical components require power from an external source in addition to the unbalanced output signal. In various example embodiments the power from an external source comprises phantom power received from a line on which the unbalanced output signal or the balanced input signal is transmitted. In various example embodiments the power from an external source comprises AC power from a line providing AC power to the instrument. In various example embodiments the electrical components comprise a preamplifier configured to provide gain to the balanced input signal. In various example embodiments the electrical components comprise an adjustment mechanism configured to adjust the level of gain. In various example embodiments the electrical components comprise a ground lift switch configured to interrupt a loop in a ground circuit comprising the musical instrument. In various example embodiments the electrical components comprise a pad switch configured to attenuate the level of the high-impedance, line level, unbalanced output signal. In various example embodiments the electrical components comprise a filter switch configured to adjust sound characteristics associated with the low-impedance microphone-level balanced input signal. In various example embodiments the electrical components comprise a pass-through connector configured to output the high-impedance, line level, unbalanced output signal from the musical instrument substantially unchanged. In various example embodiments the pass-through connector comprises a ¼ inch phone jack. In various example embodiments the electrical components comprise a ¼ inch phone jack configured to receive the high-impedance, line level, unbalanced output signal from the musical instrument. In various example embodiments the electrical components comprise an XLR connector configured to output the low-impedance microphone-level balanced input signal. In various example embodiments the support structure comprises therein electrical components configured to convert a plurality of high-impedance, line level, unbalanced output signals from a plurality of musical instruments to a corresponding plurality of low-impedance microphone-level balanced input signals.

Further provided in various example embodiments is a support structure for a musical instrument, the support structure comprising therein electrical components configured to convert a high-impedance, line level, unbalanced output signal from the musical instrument to a low-impedance microphone-level balanced input signal. In various example embodiments the support structure comprises a keyboard stand.

Also provided in various example embodiments is a support structure for a plurality of musical instruments, the support structure comprising therein electrical components configured to convert high-impedance, line level, unbalanced output signals from each of the musical instruments to a corresponding plurality of low-impedance microphone-level balanced input signals.

Additional aspects, alternatives and variations as would be apparent to persons of skill in the art are also disclosed herein and are specifically contemplated as included as part of the invention. The invention is defined only by the claims as allowed by the patent office in this or related applications, and the following figures and descriptions of certain examples are not in any way to limit, define or otherwise establish the scope of legal protection.

### BRIEF DESCRIPTION OF THE DRAWINGS

The accompanying figures illustrate certain aspects of example embodiments of the invention, wherein:

FIG. 1 is a front side perspective view of a performer adjacent a microphone supported on a microphone stand, where the performer is playing an instrument plugged-in to a direct box (or “DI box”) laying on the floor near the performer's feet, as typically done in the prior art.

FIG. 2 is a front side perspective view of a performer adjacent a microphone supported on a microphone stand, where the performer is playing an instrument plugged-in to DI components integrated into the base of the microphone stand, according to various example embodiments.

FIG. 3 is a front elevation view of the base of the microphone stand of FIG. 2, showing various example DI components according to various example embodiments.

FIG. 4 is a front side perspective view of a microphone on a microphone stand having an alternate example base with example DI components integrated therein, according to various example embodiments.

FIG. 5 is a front side perspective view of a keyboard stand having an example base with multiple sets of example DI components integrated therein, according to various example embodiments.

### DETAILED DESCRIPTION OF EXAMPLE EMBODIMENTS

Reference is made herein to some specific examples of the present invention, including any best modes contemplated by the inventor for carrying out the invention. Examples of these specific embodiments are illustrated in the accompanying figures. While the invention is described in conjunction with these specific embodiments, it will be understood that it is not intended to limit the invention to the described or illustrated embodiments. To the contrary, it is intended to cover alternatives, modifications, and equivalents as may be included within the spirit and scope of the invention as defined by the claims that will be appended in any subsequent regular utility patent application claiming priority to this provisional application.

In the following description, numerous specific details are set forth in order to provide a thorough understanding of the present invention. Particular example embodiments of the present invention may be implemented without some or all of these features or specific details. In other instances, components and process operations well known to persons of skill in the art have not been described in detail in order not to obscure unnecessarily the present invention.

Various techniques and mechanisms of the present invention will sometimes be described in singular form for clarity. However, it should be noted that some embodiments may include multiple iterations of a technique or multiple components, mechanisms, and the like, unless noted otherwise. Similarly, various steps of the methods shown and described herein are not necessarily performed in the order indicated, or performed at all in certain embodiments. Accordingly, some implementations of the methods discussed herein may include more or fewer steps than those shown or described.

Further, the techniques and mechanisms of the present invention will sometimes describe a connection, relationship or communication between two or more items or entities. It should be noted that a connection or relationship between entities does not necessarily mean a direct, unimpeded connection, as a variety of other entities or processes may reside or occur between any two entities. Consequently, an indicated connection does not necessarily mean a direct, unimpeded connection unless otherwise noted.

Provided in various example embodiments are support structures for music components, wherein the support structures themselves have incorporated therein all the components of one or more direct boxes—passive or active or both (herein generally “DI components”). The DI components (variously claimed to stand for direct input, direct injection, direct induction or direct interface) may be used with professional and semi-professional PA systems and in recording studios, for example, to connect a high-impedance, line level, unbalanced output signal to a low-impedance microphone-level balanced input, usually via an XLR connector, as described in the references incorporated herein. For example and not by way of limitation, DI components may be used to connect an electric guitar, electric bass, electric keyboard, or the like to a mixing console's microphone input. DI components can be used with instruments having electronic circuitry and pick-ups that do not contain an XLR balanced output. An example of this application would be an electric keyboard that needs to be connected to a mixer board, either directly or through an audio snake. Another example would be an acoustic guitar with pickups, an electric guitar, or bass guitar, any of which being mixed through a mixing console into a main or monitor mix. The DI components may perform level matching, balancing, and either active buffering or passive impedance matching/impedance bridging to minimize noise, distortion, and ground loops.

In various example embodiments, passive DI components may comprise an audio transformer with a turn-ratio of 12:1, and thus an impedance ratio of 144:1. With this kind of transformer, the output voltage of the instrument is stepped down to a range compatible with the typical mixing console's microphone preamp. The typical console preamp input impedance of 1,500 ohms would appear to the electronic instrument as a high input impedance of 216,000 ohms. The DI components take a high impedance, unbalanced signal and convert it to a low impedance, balanced signal. This allows the signal to be sent over long cable runs with significantly less signal loss (especially in high frequencies) due to the lowering of the impedance, and greater rejection of interference due to the benefit of common mode rejection in a balanced signal. Furthermore, the lower impedance (around 600 ohms is normal) allows an insignificant load to the input of a mixing console or preamp which is also designed to accept input from low impedance microphones.

Passive DI components may comprise an audio transformer used as a balun. The turns ratio may be chosen to convert a nominal 50,000 ohm signal source (such as the magnetic pickup of an electric guitar) to the 100-200 ohms expected by the input of an audio mixer. Example turns ratios may be in the range of 10:1 to 20:1. Alternatively, DI components may comprise a resistive load, with or without capacitor coupling. Such units are best suited to outputs designed for headphones or loudspeakers. Simple passive DI components are more susceptible to hum, and passive units tend to be less versatile than active. However, they require no batteries, are simpler to use, and may be extremely reliable when used as designed. In some example embodiments, the DI components have no settings, while in other embodiments DI components may comprise any or all of a ground lift switch (to avoid ground loop problems), a pad switch (to accommodate different source levels), and a filter switch for coloring the sound.

Active DI components may comprise a preamplifier, and thus may provide gain. Active systems require a power source, which may be provided by batteries or a standard AC outlet connection, but may alternatively be provided by phantom power as described in the references incorporated herein. Active DI components may comprise switches to enhance their versatility. These may include gain or level adjustment, ground lift, power source selection, and mono or stereo mode. In various example embodiments, ground lift switches may disconnect phantom power.

DI components may further comprise a pass-through connector, such as a second phone connector or jack, for instance simply paralleled to the input connector that delivers the input signal unchanged, to allow the DI components to be inserted into a signal path without interrupting it. Pass-through is also commonly referred to as a bypass. True-bypass occurs when the signal goes straight from the input jack to the output jack with no circuitry involved and no loading of the source impedance. False bypass (or simply ‘bypass’) occurs when the signal is routed through the device circuitry with buffering and no other intentional change to the signal. However, due to the nature of electrical designs there is almost always some slight change in the signal. The extent of change and how noticeable it may be can vary from unit to unit.

While not limited to these embodiments, DI components may typically be used for instruments or other devices that only contain an unbalanced ¼″ phone output which needs to be connected to an XLR input.

A ¼″ phone output refers to a common family of connectors typically used for analog signals, primarily audio. It is cylindrical in shape, typically with two, three or four contacts. Three-contact versions are known as TRS connectors, where T stands for “tip”, R stands for “ring” and S stands for “sleeve”. The phone connector was invented for use in telephone switchboards in the 19th century and is still widely used. In its original configuration, the outside diameter of the “sleeve” conductor is ¼ inch (exactly 6.35 mm). Phone connectors with three conductors are also commonly used as unbalanced audio patch points (or insert points, or simply inserts), with the output on many mixers found on the tip (left channel) and the input on the ring (right channel). This is often expressed as “tip send, ring return”. Other mixers have unbalanced insert points with “ring send, tip return”. One advantage of this system is that the switch contact within the panel socket, originally designed for other purposes, can be used to close the circuit when the patch point is not in use. An advantage of the tip send patch point is that if it is used as an output only, a 2-conductor mono phone plug correctly grounds the input. In the same fashion, use of a “tip return” insert style allows a mono phone plug to bring an unbalanced signal directly into the circuit, though in this case the output must be robust enough to withstand being grounded. Combining send and return functions via single ¼ in TRS connectors in this way is seen in very many professional and semi-professional audio mixing desks, due to the halving of space needed for insert jack fields which would otherwise need two jacks, one for send and one for return. The tradeoff is that unbalanced signals are more prone to buzz, hum and outside interference.

An XLR connector is a style of electrical connector, primarily found on professional audio, video, and stage lighting equipment. XLR connectors are circular in design and have between 3 and 7 pins. They are most commonly associated with balanced audio interconnection, including AES3 digital audio, but are also used for lighting control, low-voltage power supplies, and other applications. XLR connectors are available from a number of manufacturers and are covered by an international standard for dimensions, IEC 61076-2-103. They are superficially similar to the older and smaller DIN connector range, but are not physically compatible with them.

Multiple sets of DI components can be mounted inside one support structure for music components, such as a microphone stand or a keyboard stand. Multiple sets of DI components may be used for multiple unbalanced outputs, such as for a bank of electronic keyboards, electronic synthesizers, or any other unbalanced outputs. Wiring diagrams and depictions of the internal components of DI boxes are not separately reproduced herein, because such information is already known in the art of DI boxes, and example structures are disclosed with specificity in the art that is incorporated herein by reference. Unless specifically claimed, the present invention is not limited to any particular DI components, circuits, or other structure.

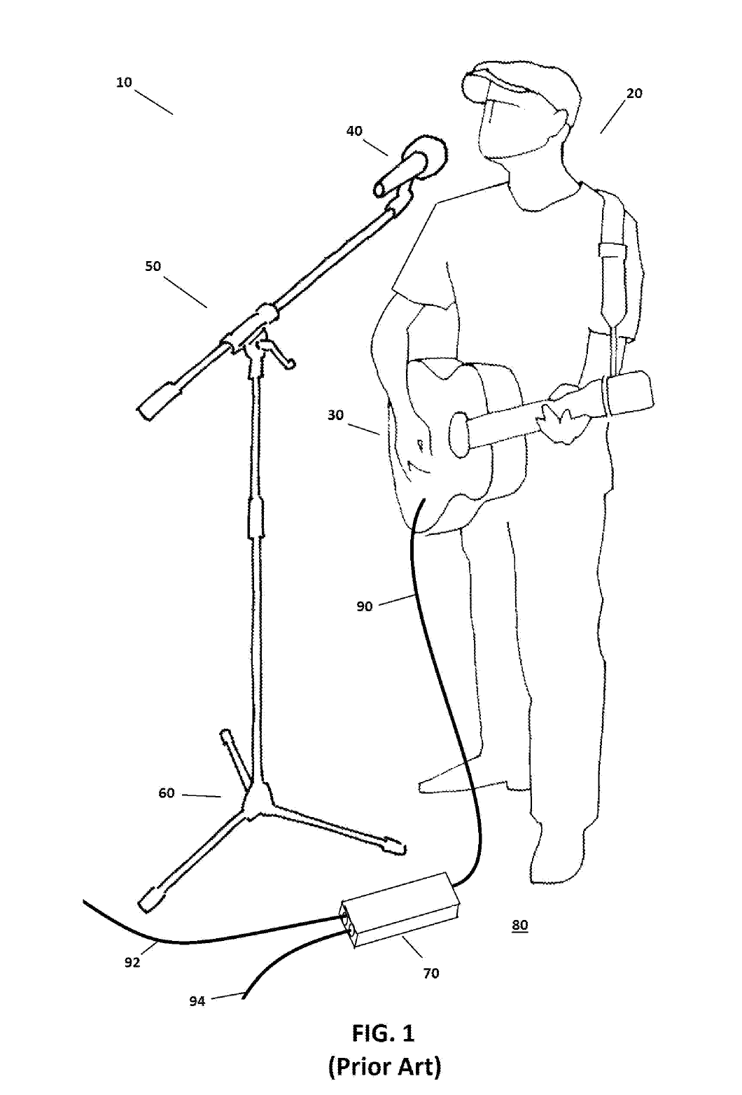

With reference to the figures, FIG. 1 depicts typical prior art systems 10 where direct boxes 70 are usually placed on the stage floor 80 near the feet of the performer 20, so that the performer's instrument(s) 30 can be readily plugged-in to the direct box(es) 70 with a minimal length of interference-prone wire or cable 90 (i.e., the cable carrying the high-impedance, line level, unbalanced output signal from the musical instrument 30), which may then be plugged-in to XLR wires or cable 92, which may carry a low-impedance microphone-level balanced input signal to a distant mixing board or other components (not shown), for instance. Wire or cable 94 may for example be plugged-in to a pass-through in the direct box 70, for instance to transmit the substantially unaltered high-impedance, line level, unbalanced output signal from the musical instrument 30 to an amplifier (not shown), for example. But in the already-crowded stage area 80 where the performer 20 must perform, the presence of one or more electronics boxes 70 laying on the stage floor 80 is a visually unappealing trip-hazard, and an unwanted distraction and danger for the performer 20. What is needed is a convenient and visually appealing way to remove the direct box 70 from the stage floor and place it out of sight while keeping it near the performer's instrument(s) 30.

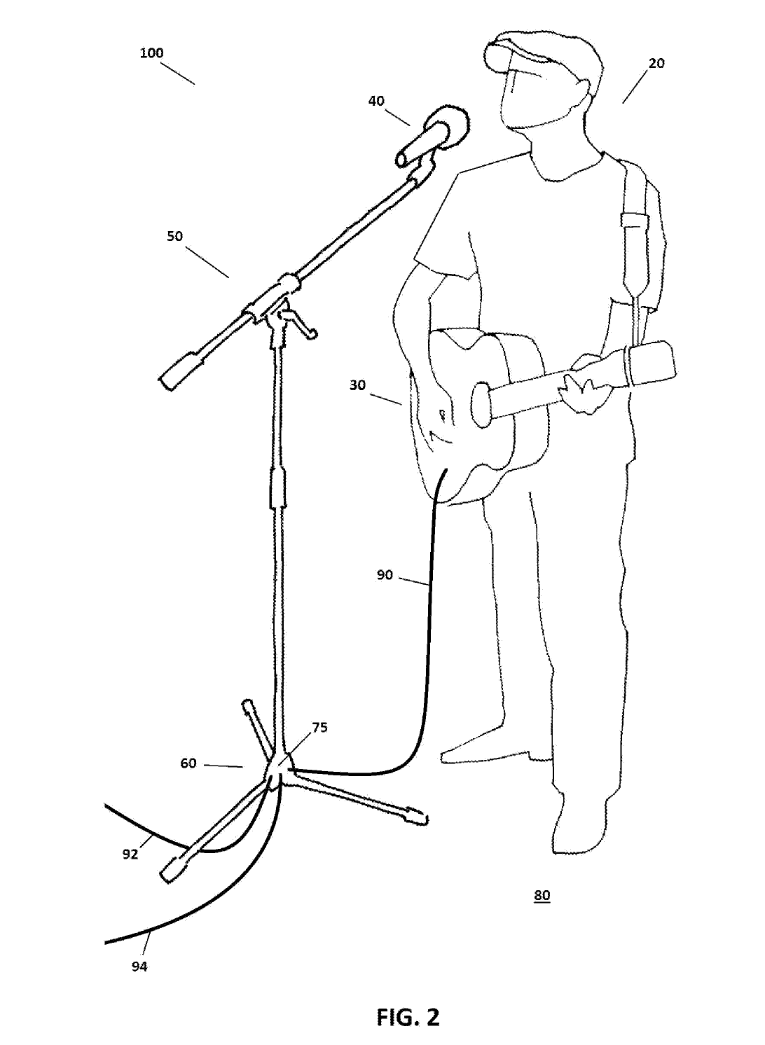

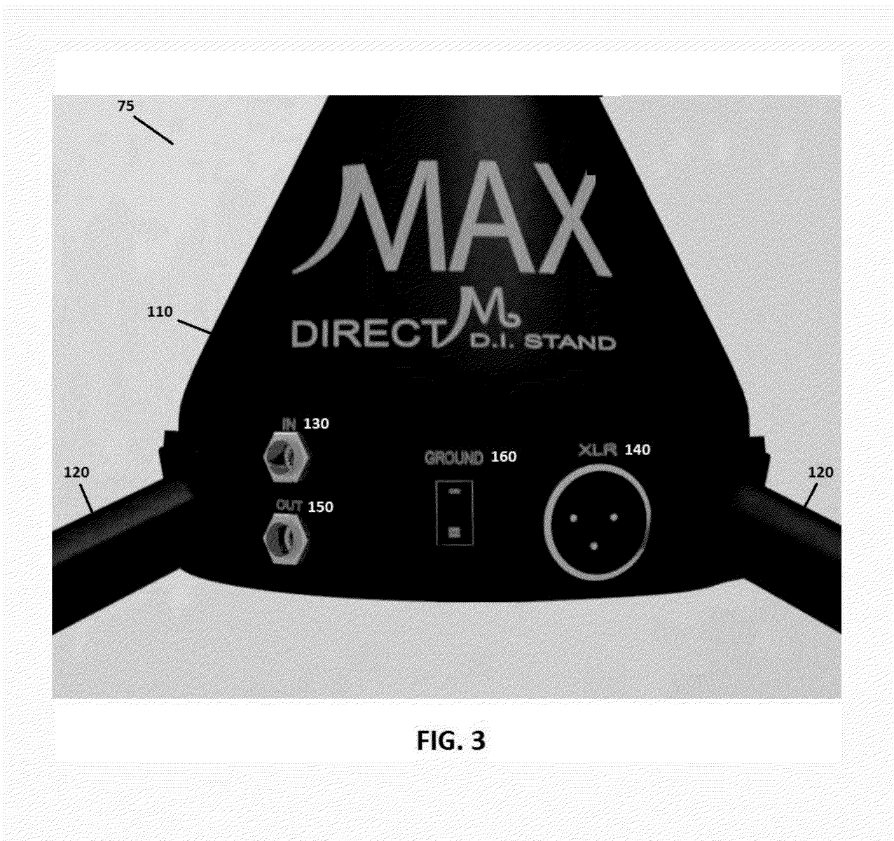

As shown in the example embodiments depicted in FIGS. 2-5, the present invention provides a novel solution to these problems and provides additional benefits. For example, with respect to FIGS. 2 and 3, provided in various example embodiments is a support structure 50 for a microphone 40, the support structure 50 comprising a hollow base portion 60 housing electrical components configured to convert a high-impedance, line level, unbalanced output signal from a musical instrument 30 to a low-impedance microphone-level balanced input signal. In various example embodiments the support structure comprises a base portion 60 of a microphone stand 50. In various example embodiments the electrical components are configured to function passively without a power source aside from the unbalanced output signal, which may be transmitted by a minimal length of interference-prone wire or cable 90, for instance (i.e., the cable carrying the high-impedance, line level, unbalanced output signal from the musical instrument 30). In various example embodiments the electrical components comprise an audio transformer configured to act as a balun, as described in the art, including in the art incorporated herein. In various example embodiments the electrical components require power from an external source in addition to the unbalanced output signal. In various example embodiments the power from an external source comprises phantom power received from a line on which the unbalanced output signal 90 or the balanced input signal 92 is transmitted.

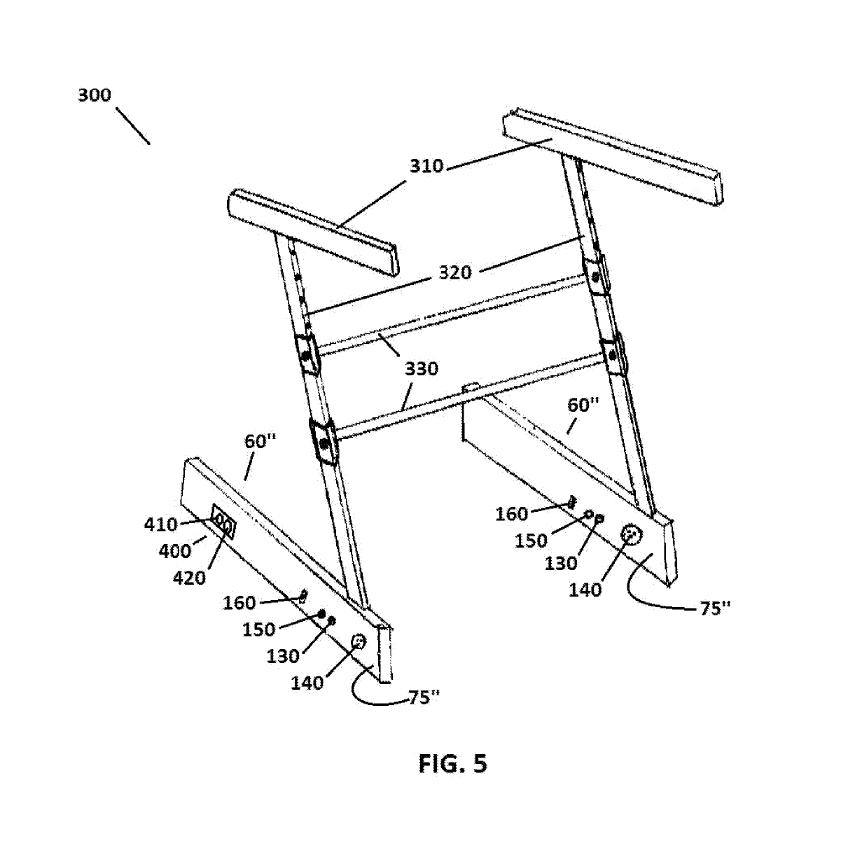

In various example embodiments the power from an external source comprises AC power from a line providing AC power to the instrument. For instance with respect to FIG. 5, an AC interface 400 may be provided in the support structure 300, including for example a male plug 410 for plugging into an extension cord or the like, and a female plug 420 for plugging-in the instrument (not shown). In those types of embodiments the DI components in the support structure 300 may draw power available from the AC interface 400, for instance by wiring (not shown) inside the support structure 300, in which case the DI components may draw power from the same source as the instrument.

In various example embodiments the electrical DI components housed in the support structure may comprise a preamplifier (not shown) configured to provide gain to the balanced input signal, as is known in the art of DI boxes. In various example embodiments the electrical components housed in the support structure may comprise an adjustment mechanism (not shown) configured to adjust the level of gain, as is known in the art of DI boxes. In various example embodiments the electrical components housed in the support structure may comprise a ground lift switch 160 configured to interrupt a loop in a ground circuit comprising the musical instrument 30, as is known in the art of DI boxes. In various example embodiments the electrical components housed in the support structure may comprise a pad switch (not shown) configured to attenuate the level of the high-impedance, line level, unbalanced output signal, as is known in the art of DI boxes. In various example embodiments the electrical components housed in the support structure may comprise a filter switch configured to adjust sound characteristics associated with the low-impedance microphone-level balanced input signal, as is known in the art of DI boxes. In various example embodiments the electrical components housed in the support structure may comprise a pass-through connector 150 configured to output the high-impedance, line level, unbalanced output signal from the musical instrument 30 substantially unchanged, as is known in the art of DI boxes. In various example embodiments the pass-through connector may comprise a ¼ inch phone jack 150, as best shown in FIG. 3. In various example embodiments the electrical components housed in the support structure may comprise a ¼ inch phone jack 130 configured to receive the high-impedance, line level, unbalanced output signal from the musical instrument 30, as best shown in FIG. 3. In various example embodiments the electrical components housed in the support structure may comprise an XLR connector 140 configured to output the low-impedance microphone-level balanced input signal, as best shown in FIG. 3.

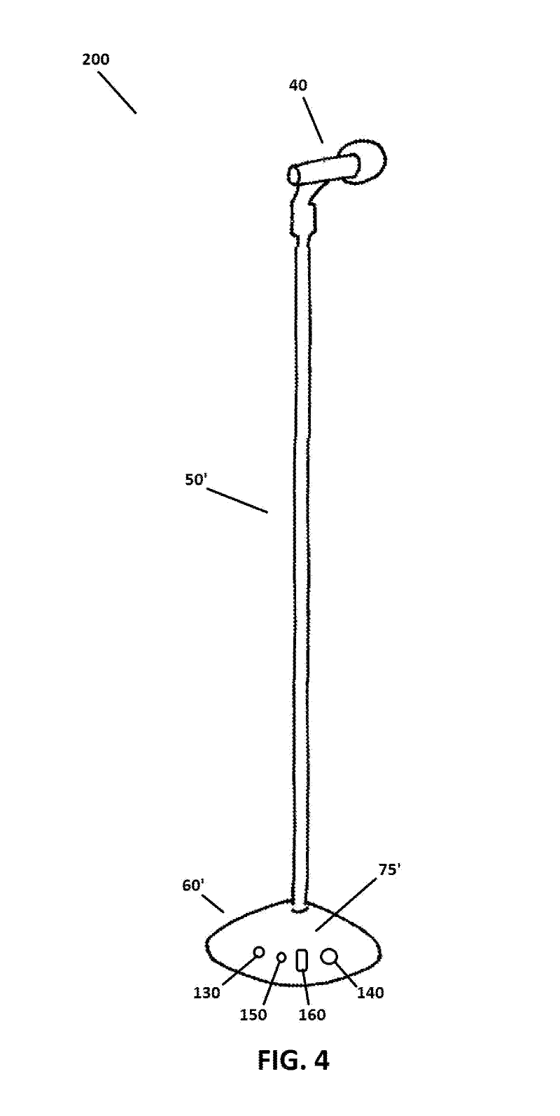

In various example embodiments, for instance as shown in FIG. 5, the support structure 300 may comprise therein electrical components configured to convert a plurality of high-impedance, line level, unbalanced output signals from a plurality of musical instruments to a corresponding plurality of low-impedance microphone-level balanced input signals (see, e.g., multiple sets of components 130, 140, 150, 160). While the support structure 300 shown in FIG. 5 is a keyboard stand, having keyboard supporting members 310 supported by upright members 320 connected by struts 330, all supported on two bases 60″ each defining hollow portions 75″ containing respective DI electronics 130, 140, 150, 160, etc., it should be understood that multiple sets of DI electronics can be provided in the hollow portion 75 of the base 60 of the support structure 50 depicted FIGS. 2 and 3, or the hollow portion 75′ of the base 60′ of the support structure 50′ depicted in FIG. 4, or in any other support structure for music components, including support structures for musical instruments. For example, the support structure may in various example embodiments comprise a keyboard stand configured to support a plurality of keyboards (the term keyboard broadly including electric pianos, synthesizers, and the like).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. Certain information recited herein was obtained from the online encyclopedia Wikipedia, pursuant to Wikipedia's Creative Commons Attribution-ShareAlike License, available online.

Any of the suitable technologies set forth and incorporated herein may be used to implement various example aspects of the invention as would be apparent to one of skill in the art.

Although exemplary embodiments and applications of the invention have been described herein including as described above and shown in the included example Figures, there is no intention that the invention be limited to these exemplary embodiments and applications or to the manner in which the exemplary embodiments and applications operate or are described herein. Indeed, many variations and modifications to the exemplary embodiments are possible as would be apparent to a person of ordinary skill in the art. The invention may include any device, structure, method, or functionality, as long as the resulting device, system or method falls within the scope of one of the claims that are allowed by the patent office based on this or any related patent application.

1. A support structure for a microphone, the support structure comprising therein electrical components configured to convert a high-impedance, line level, unbalanced output signal from a musical instrument to a low-impedance microphone-level balanced input signal.

2. The support structure of claim 1, wherein the support structure comprises a base portion of a microphone stand.

3. The support structure of claim 1, wherein the electrical components are configured to function passively without a power source aside from the high-impedance, line level, unbalanced output signal from the musical instrument.

4. The support structure of claim 3, wherein the electrical components comprise an audio transformer configured to act as a balun.

5. The support structure of claim 1, wherein the electrical components require power from an external source in addition to the high-impedance, line level, unbalanced output signal from the musical instrument.

6. The support structure of claim 5, wherein the power from the external source comprises phantom power received from a line on which the high-impedance, line level, unbalanced output signal from the musical instrument or the low-impedance microphone-level balanced input signal is transmitted.

7. The support structure of claim 5, wherein the power from an external source comprises AC power from a line providing AC power to the musical instrument.

8. The support structure of claim 5, wherein the electrical components comprise a preamplifier configured to provide gain to the low-impedance microphone-level balanced input signal.

9. The support structure of claim 8, wherein the electrical components comprise an adjustment mechanism configured to increase or decrease the gain.

10. The support structure of claim 1, wherein the electrical components comprise a ground lift switch configured to interrupt a loop in a ground circuit comprising the musical instrument.

11. The support structure of claim 1, wherein the electrical components comprise a pad switch configured to attenuate the high-impedance, line level, unbalanced output signal.

12. The support structure of claim 1, wherein the electrical components comprise a filter switch configured to adjust sound characteristics associated with the low-impedance microphone-level balanced input signal.

13. The support structure of claim 1, wherein the electrical components comprise a pass-through connector configured to output the high-impedance, line level, unbalanced output signal from the musical instrument substantially unchanged.

14. The support structure of claim 13, wherein the pass-through connector comprises a ¼ inch phone jack.

15. The support structure of claim 1, wherein the electrical components comprise a ¼ inch phone jack configured to receive the high-impedance, line level, unbalanced output signal from the musical instrument.

16. The support structure of claim 1, wherein the electrical components comprise an XLR connector configured to output the low-impedance microphone-level balanced input signal.

17. The support structure of claim 1, comprising therein electrical components configured to convert a plurality of high-impedance, line level, unbalanced output signals from a plurality of musical instruments to a corresponding plurality of low-impedance microphone-level balanced input signals.

18. A support structure for a musical instrument, the support structure comprising therein electrical components configured to convert a high-impedance, line level, unbalanced output signal from the musical instrument to a low-impedance microphone-level balanced input signal.

19. The support structure of claim 18, wherein the support structure comprises a keyboard stand.

20. A support structure for a plurality of musical instruments, the support structure comprising therein electrical components configured to convert high-impedance, line level, unbalanced output signals from each of the musical instruments to a corresponding plurality of low-impedance microphone-level balanced input signals.
